(19) United States
(12) Patent Application Publication
(10) Pub. No.: US 2017/0024991 A1
(43) Pub. Date: Jan. 26, 2017

(54) SOCIALLY-NETWORKED SYSTEM FOR NEIGHBORHOOD PLAY

(71) Applicant: PLAYCELETS INC., Stanford, CA (US)

(72) Inventors: Amy R. Butte, Stanford, CA (US); Gregory J. Wolff, Palo Alto, CA (US)

(21) Appl. No.: 15/214,361

(22) Filed: Jul. 19, 2016

Related U.S. Application Data
(60) Provisional application No. 62/194,724, filed on Jul. 20, 2015.

(51) Int. Cl. G08B 21/02; G08B 21/24; H04L 12/58

(52) U.S. Cl. CPC G08B 21/0227; H04L 51/32; H04L 51/20; H04L 51/34; G08B 21/24; G08B 21/0288

(57) ABSTRACT

A system includes a wearable device including a wireless communication interface and a user interface, and instructions stored in a tangible computer-readable memory. The instructions include instructions to provide a graphical user interface, receive at the graphical user interface instructions for creating an invitation including a destination and a list of invitees, send to a server a description of the invitation, receive from the server a notification that the invitation was delivered, and instruct the first wearable device to indicate that the invitation was delivered.

### CROSS-REFERENCE TO RELATED PATENT APPLICATIONS

This application claims the benefit of and priority to U.S. Provisional Patent Application 62/194,724 filed Jul. 20, 2015 to Butte et al., titled “Socially-Networked System for Neighborhood Play,” the contents of which are incorporated herein by reference in their entirety.

### BACKGROUND

The social network that used to exist among children outdoors in neighborhoods has collapsed and largely disappeared. Studies indicate that only about six percent of children play outside in the neighborhood, whereas approximately ninety-eight percent of the same children's parents played outside in the neighborhood when they were young. Thus, in just one generation, there has been a significant decrease in neighborhood play. There are many reasons for this decrease, including parents' wariness in allowing children to play unsupervised, parents' schedules that do not allow for constantly-supervised play, and the collapse of the “network effect” of kids commonly being outside to play with at any time. Gone are the days when children went outside to play in the morning and returned home for meals, without parental contact in the meantime.

However, it is important for children to participate in social play for healthy mental, emotional, social, and physical development. It is therefore desirable to have a way to allow for the children to easily and spontaneously gather for play while providing the parents a way to monitor the children from a distance.

### SUMMARY

In one or more embodiments, a system includes a wearable device including a wireless communication interface and a user interface, and instructions stored in a tangible computer-readable memory. The instructions include instructions to provide a graphical user interface, receive at the graphical user interface instructions for creating an invitation including a destination and a list of invitees, send to a server a description of the invitation, receive from the server a notification that the invitation was delivered, and instruct the first wearable device to indicate that the invitation was delivered.

In one or more embodiments, a computer program product includes instructions to provide a graphical user interface, receive at the graphical user interface instructions for creating an invitation including a destination and a list of invitees, send to a server a description of the invitation, receive from the server a notification that the invitation was delivered, and instruct a wearable device to indicate that the invitation was delivered.

In one or more embodiments, a bracelet including a graphical user interface, a wireless interface, and a controller configured to receive instructions through the wireless interface to control the graphical user interface to indicate that a request is pending, and further configured to provide a notification through the wireless interface.

In one or more embodiments, a server includes a processor and a memory having instructions stored thereon configured to cause the processor to receive a request for a meeting from a computing device associated with an inviter, the request including identifiers of a location and at least one invitee, transmit a notification of the request for the meeting to a computing device associated with the invitee, receive an acceptance from the computing device associated with the invitee, transmit a notification of the acceptance to the computing device associated with the inviter, receive a notification of an arrival of the invitee at the location, and transmit a notification of the arrival to the computing device associated with the invitee.

### BRIEF DESCRIPTION OF THE DRAWINGS

FIG. 1 illustrates an example of a socially-networked system for neighborhood play in accordance with an embodiment of the present disclosure.

FIG. 2 illustrates an overview of an example of functionality for a socially-networked system for neighborhood play in accordance with an embodiment of the present disclosure

FIG. 3 illustrates an example of new family registration in a socially-networked system for neighborhood play in accordance with an embodiment of the present disclosure.

FIG. 4 illustrates an example of friend invitation in a socially-networked system for neighborhood play in accordance with an embodiment of the present disclosure.

FIG. 5 illustrates an example of responses in a socially-networked system for neighborhood play in accordance with an embodiment of the present disclosure.

FIG. 6 illustrates an example of check-ins in a socially-networked system for neighborhood play in accordance with an embodiment of the present disclosure.

FIG. 7 illustrates an example of child-in-range checks in a socially-networked system for neighborhood play in accordance with an embodiment of the present disclosure.

FIG. 8 illustrates an example of child status monitoring in a socially-networked system for neighborhood play in accordance with an embodiment of the present disclosure.

FIG. 9 illustrates an example of come home signaling in a socially-networked system for neighborhood play in accordance with an embodiment of the present disclosure.

FIG. 10A, FIG. 10B, FIG. 10C and FIG. 10D illustrate examples of communication in a socially-networked system for neighborhood play by way of a graphical user interface, in accordance with an embodiment of the present disclosure.

FIG. 11A, FIG. 11B and FIG. 11C illustrate examples of communication in a socially-networked system for neighborhood play by way of a graphical user interface, in accordance with an embodiment of the present disclosure.

### DETAILED DESCRIPTION

Rather than allowing unsupervised neighborhood play as in times gone by, parents may opt for setting up “play dates” in advance. However, play dates are difficult to schedule, usually involve a small number of children, and are infrequent. It would be preferable to allow for spontaneous neighborhood play with a more varied group of children. Described in the present disclosure is a system for allowing such a neighborhood community of children.

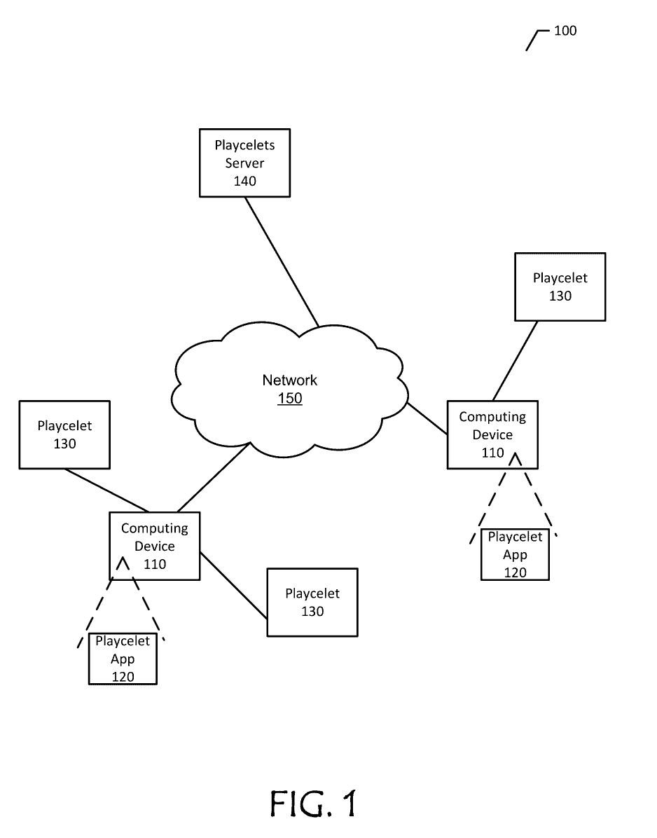

FIG. 1 illustrates a system for facilitating community interaction. Computing devices (shown as components 110), each with a software application (referred to in this disclosure as “the Playcelet app”, shown as component 120) represent the community. Each Playcelet app communicates with one or more Playcelets (shown as components 130). For example, a parent may own a computing device, and may use the Playcelet app to register one or more of their children in a community. Each child is associated with a Playcelet. Alternatively, the Playcelet is associated with the Playcelet app and shared among multiple children, such that it is assigned to a child when used.

The Playcelet apps on the computing devices communicate with a Playcelets server (shown as component 140) through a network (shown as component 150). Computing devices include mobile phones, personal digital assistants, dedicated Playcelet devices, tablets, laptop computers, netbooks, notebooks, tower computers, or other computing devices. The Playcelets server is also a computing device, and includes programming to perform the functions described elsewhere in the present disclosure. The network represents any one or more networks, such as analog or digital, public or private, wired or wireless, local area or wide area, or other networks.

The Playcelet app is used to create invitations, and then monitor invitees to verify that they reach and stay at the destination specified in the invitation, and that they return home at the end of the invitation time. The term “destination” is used to indicate a geographic location at which an inviter's computing device is intended to be at the time specified in the invitation. For example, if a parent lets a child invite several friends to the child's home using the Playcelet app, then the destination is the child's home; however, monitoring of arrival and stay at the child's home is accomplished by the Playcelet app on the parent's computing device.

Playcelets allows children to gather spontaneously for neighborhood play, making it easy and quick to create neighborhood social play networks. The Playcelets system allows for networking groups of neighborhood friends to facilitate children's social play in the neighborhood.

A Playcelet is a small wearable device that receives signals from, and transmits signals to, a social network via a mobile phone. For example, a Playcelet transmits signals to, and receives signals from, a caregiver's mobile phone (a caregiver being a parent, a grandparent, or a sitter, for example) wirelessly, such as through a Bluetooth protocol interface. Other possibilities for wireless data communication by the Playcelet are WiFi or cellular connection. Additionally, the Playcelet may include GPS, GSM (cell tower trilateration), or Wifi trilateration capability for tracking device locations. The Playcelet is programmed to maintain efficient wireless communication in order to continuously monitor the presence of the device.

In one or more embodiments, a Playcelet is in the form of a bracelet. There is graphical user interface (GUI) on the Playcelet. In one or more embodiments, the GUI includes light emitting diodes (LEDs) and one or more buttons, where information is viewed by way of the LEDs and input by way of the button. In one or more embodiments, the GUI additionally or alternatively includes one or more of a touch LCD screen, an e-ink, or other technologies of colored lights (e.g., not LEDs).

In one or more embodiments, data transmitted among computing devices and Playcelets across networks is encrypted and secure. For example, each Playcelet charm includes a public/private key pair stored securely on the device. The public key is used as an identifier for that Playcelet, and the private key is used to decrypt messages.

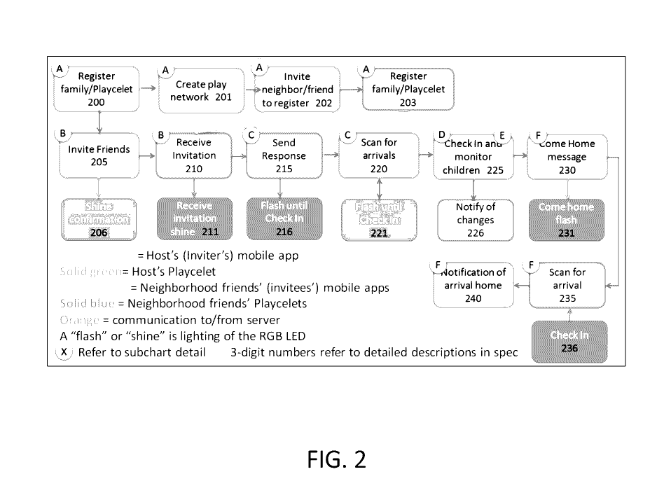

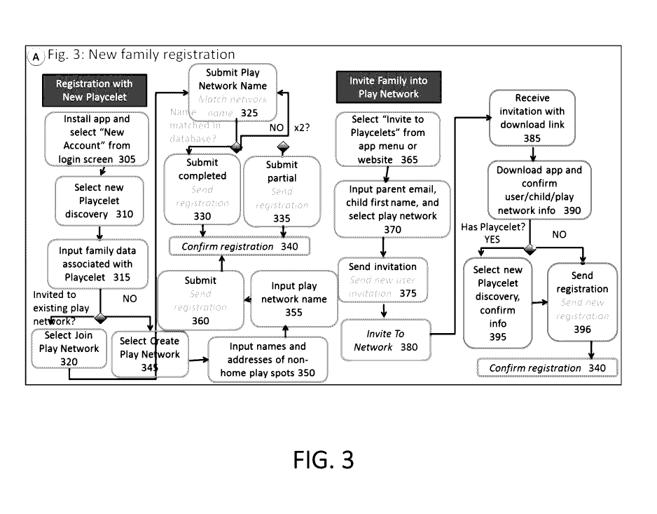

FIGS. 2-8 are flowcharts illustrating functionality of one embodiment of a system in accordance with the present disclosure. In this embodiment, the GUI is described with respect to LEDs for convenience. FIG. 2 is an overview of the system functionality, and FIGS. 3-8 provide details. In FIGS. 2-8, at least two children have Playcelets, and the Playcelets are part of a social network supported by a Playcelet app. Generally, the Playcelet app is accessed on a mobile phone or other mobile device; however, the Playcelet app may also be accessed on other types of computing devices.

Referring to FIG. 2, a family registers (at block 200) an account with Playcelets via the Playcelet app or a web page and creates (at block 201) a Play Network. The family can then invite other families to register. In the example of FIG. 2, for simplicity of description, a family invites (at block 202) one other family to register, and the invited family registers (at block 203). A play date is initiated (at block 205) by accessing the Playcelet app and inviting one or more friends in the social network to play. A Playcelet associated with the instance of the Playcelet app initiating the invitation provides (at 206) an indication at the GUI of the Playcelet that the invitation has been sent. For example, when a child invites friends to play, a light in the child's Playcelet turns on to indicate that there is an active invitation. The friends receive (at block 210) the invitation, and each of the Playcelets associated with the invited friends provides (at block 211) an indication of the invitation at the GUI. For example, if four friends are invited, lights in the four Playcelets associated with those four friends turn on to indicate that an invitation was received. The friend (or caregiver) can access the Playcelet app to view the invitation, and if desired, to respond (at block 215). If a response is sent (at block 215) and the response is affirmative, the friend's Playcelet provides a “waiting” indication (at block 216) until the Playcelet is checked in, as described below. For example, a light on the friend's Playcelet flashes periodically to indicate that it is waiting for an action to occur. The Playcelet app associated with the inviter's Playcelet (or the inviter's Playcelet itself) scans (at block 220) for the Playcelets of the friends that responded affirmatively, until all of the friends' Playcelets are checked in. The Playcelet of the inviting person may also provide (at block 221) an indication (such as a flashing light) until the Playcelet of each friend that responded affirmatively to the invitation has checked in.

While the friends are playing, the Playcelet app of the inviter monitors (at block 225) the presence and other attributes of the inviter and the friends, and may notify (at block 226) the Playcelet app of one or more of the invitees if a change occurs. For example, if one of the Playcelets goes out of range from the Playcelet app for a specified amount of time, or if an attribute of the child changes (such as the child's temperature passes a positive or negative threshold, or increases/decreases more than a specified amount or percentage, or such as the child's heart rate speeds up or slows down consistent with an identifiable problem, or fear), the Playcelet app of the inviter may notify the Playcelet app of the caregiver of that child. Additionally, each caregiver may monitor (at block 225) the Playcelet of the child under their care, such as for a physical proximity to the inviter's Playcelet, a number of other Playcelets in proximity to the child's Playcelet, and attributes of the child. The Playcelet may include detection of removal of the Playcelet, such as a continuity detector, a switch on a locking mechanism, an expansion detector, or other detection, and the Playcelet apps of the inviter and the caregiver may also identify whether the Playcelet has been taken off. The Playcelet may include biophysical detectors, such as heart rate or biochemical detectors, and the caregiver's Playcelet app (and the inviter's Playcelet app if permission is so granted) may monitor whether the Playcelet is being worn by the appropriate child based on pre-identified heart rate or biochemical patterns of that child. The inviter's Playcelet app may monitor heart rate or biochemical patterns detected by the friend's Playcelet, and provide the detected patterns to the caregiver's Playcelet app for identification based on pre-identified heart rate or biochemical patterns of the friend, so that privacy concerns are reduced.

When it is time to send the children home, the Playcelet app of the inviter is accessed to provide (at block 230) a message to the Playcelet apps of each of the friends checked in. The Playcelet of each friend provides (at block 231) a notification (such as a flashing light) that the Playcelet is waiting for check-in by the caregiver's Playcelet app. Additionally, the Playcelet of the inviter may provide an indication, until each of the friends have been checked in by their respective caregiver's Playcelet app. Each caregiver's Playcelet app scans (at block 235) for the arrival of the Playcelet of the associated child, and the Playcelet checks in (at block 236) when it is within communication distance of the associated Playcelet app. The Playcelet app then sends a notification to the Playcelet app of the inviter that the friend has checked in at home.

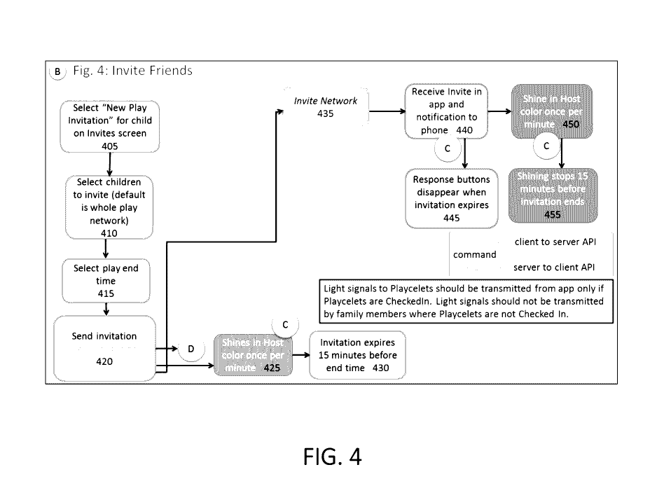

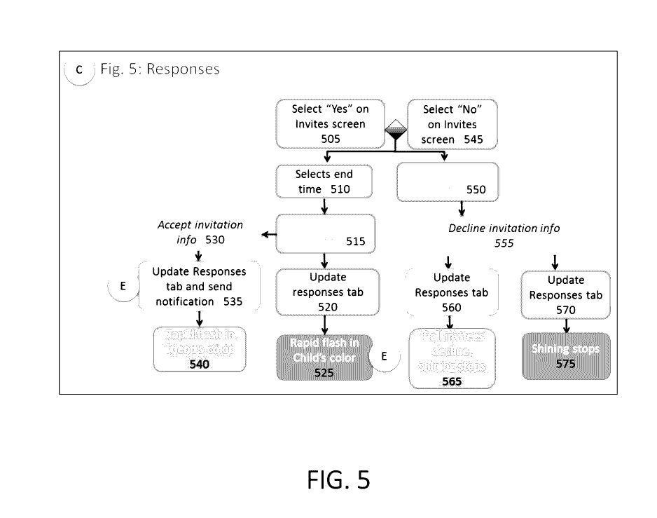

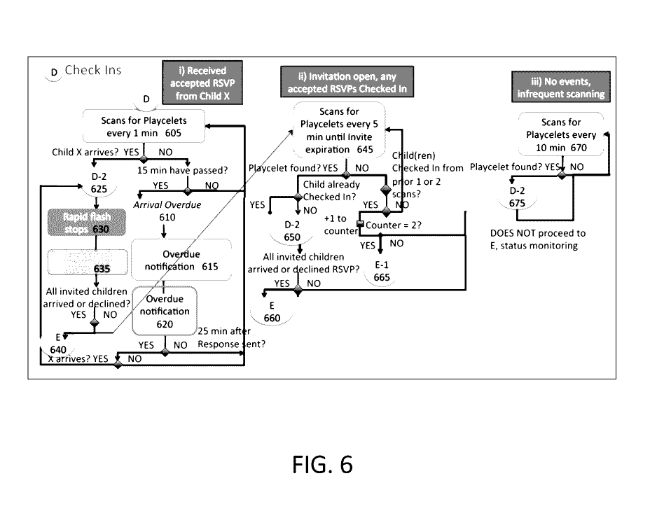

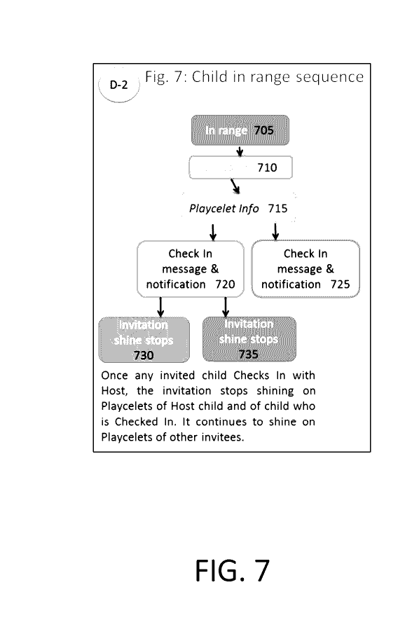

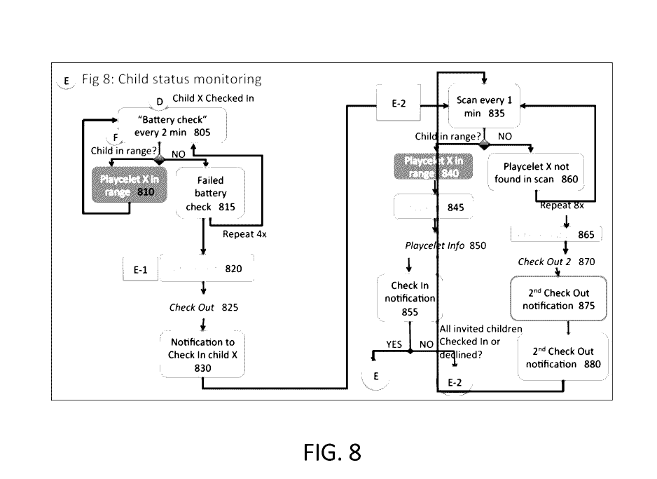

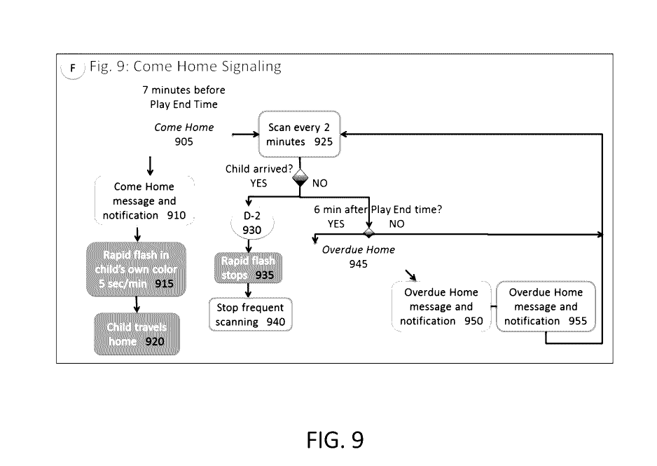

In FIG. 2, blocks 200, 201, 202, and 203 are marked with an ‘A’ in the upper left corner to indicate that more detail is provided in FIG. 3; blocks 205 and 210 are marked with a ‘B’ in the upper left corner to indicate that more detail is provided in FIG. 4; blocks 215, 220 are marked with a ‘C’ in the upper left corner to indicate that more detail is provided in FIG. 5; block 225 is marked with a ‘D’ in the upper left corner to indicate that more detail is provided in FIGS. 6 and 7, and an ‘E’ in the upper right corner to indicate that more detail is provided in FIG. 8; and blocks 230, 235 and 240 are marked with an ‘F’ in the upper left corner to indicate that more detail is provided in FIG. 9.

Referring to FIG. 3, an example of the initial registration of Playcelets into the social network (blocks 200-203 in FIG. 2) is provided. A user (e.g., parent) installs (at block 305) the Playcelet app and selects “New Account” from the login screen. The Playcelet app is used to discover (at block 310) a new Playcelet that has been purchased for (or otherwise received by) a child who is to be associated with the new account and who will wear the Playcelet. The user inputs (at block 315) information about the child and information about the family member or caregiver who controls (e.g., owns) the phone or other device on which the Playcelet app is installed. Then, if the family has been invited by another family to join their child's play network, the user selects (at block 320) “Join Play Network.” The user enters (at block 325) the name of the play network to which they were invited. In some embodiments, the name of the play network must be entered exactly, and in other embodiments, a code for the play network is entered. In some embodiments, a verification code must be submitted as well. If the Playcelets server finds (at block 330) a match for the name of the play network, the complete registration will be submitted and the family is registered to Playcelets. If the play network name cannot be matched, the registration will be submitted (at block 335) without the child joining a play network. The Playcelets server will then send (at block 340) a confirmation of the registration, for example by email.

If there was no play network invitation outstanding (at block 320), the user (e.g., parent or caregiver) is able to create (at block 345) a new play network for the child. To do so, the user inputs (at block 350) names or addresses of neighborhood locations, such as parks or recreation centers, that their new neighborhood play network might use as a gathering spot. The user inputs (at block 355) a name for the play network, for example, “Oak Street Friends” or “Pine Hill Players.” The registration is submitted (at block 360), including the new play network, and registration is confirmed (at block 340) by the Playcelets server.

As discussed with respect to FIG. 2 (at block 202) families can invite other families into their Play Network, whether or not those families have yet purchased a Playcelet. To invite a family, the user selects (at block 365) such an option through a button on the Playcelet app or a website. The inviter inputs (at block 370) the invitee parent's email, the child's first name, and the name of the play network to which the child is invited. The inviter sends (at block 375) the invitation, and the Playcelets server transmits (at block 380) an invitation to the invitee parent. The invited parent receives (at block 385) the invitation, such as in an email, with a link to download the Playcelet app. The invitee user (e.g., parent or caregiver) may download (at block 390) the Playcelet app to a device (e.g., a mobile phone). If the invitee family has already purchased a Playcelet, the invitee user will use the Playcelet app (at block 395) to discover the new Playcelet's unique identifier, such as its MAC address or a public/private key pair. The invitee user sends (at block 396) the new registration, including the child and Playcelet identification info, to the Playcelets server, which confirms (at block 340) the registration, such as via an email.

Referring to FIG. 4, an example of the invite functionality of FIG. 2 (blocks 205, 206, 210, 211) is provided. An inviter accesses the Playcelet app, and selects (at block 405) to make a new invitation. As there may be more than one child associated with the Playcelet app, the inviter selects the button for a new invitation next to the child's name who is to be indicated as the inviter (whether or not the child is the one creating the invitation). In some embodiments, the invitation includes a notification of who prepared the invitation. For example, a caregiver enters a password so that the Playcelet app includes the caregiver's name on the invitation as the preparer of the invitation. The friends to invite to play are selected (at block 410). The entire play network may be pre-selected as a default, such as in a single pre-selection (e.g., “whole play network”) or by a pre-selection of each name in the network. The default pre-selection may be cleared as a whole with one de-selection, or certain names may be individually de-selected. For example, if it is known that a friend is away on vacation, that friend may be de-selected. In some embodiments, the Playcelet app may include an unavailability setting, such that play invitations are automatically blocked during times marked as unavailable, and the Playcelet app may provide an option for a message to be sent back with respect to the unavailability. Such a message may terminate the invitation to the unavailable child; alternatively, the blocked invitation is allowed to expire without termination.

If desired, the play invitation may include start and/or end times. If no start time is selected, the start time is, by default, immediate. If no end time is selected (at block 415), the end time is, by default, open-ended. A specific end time may be set, or a time duration may be specified beginning from a specific start time. The play date may be ended (whether or not an end time was specified) with respect to one or more of the friends checked in when an end of play notification is entered on the inviter's Playcelet app. The play date may be ended with respect to one friend checked in when an end of play notification is entered on the caregiver's Playcelet app associated with that friend. In this manner, the caregiver of the inviter may send one or more children home, and a caregiver of a friend may summon the friend home.

An invitation may further include a location. By default, the location is the home of the inviter. The location may be by address, by coordinates, by map location, or by a code word that is known by participants in the play network, such as “Playspot3”.

Once the play invitation is prepared, it is sent (at block 420) to the Playcelets server for distribution within the play network. The Playcelet associated with the inviter child (whether or not the child prepared the invitation) indicates that an invitation has been sent to the Playcelets server. For example, a light in the Playcelet turns on (at block 425) for a short duration once every minute. The invitation expires (at block 430) fifteen minutes (or other amount of time selected) before the selected end time of the invitation. If the end time was left open-ended in the invitation, the expiry of the invitation is at a set time, or after a set amount of time from sending the invitation. In some embodiments, the expiry of the invitation is set by default, such as after one hour, and may be changed when making the invitation or subsequent to sending the invitation. In some embodiments, the invitation may be canceled with respect to selected invitees subsequent to sending the invitation, such as if the invitees did not respond before the play group moves to a new location.

The Playcelets server sends (at block 435) the play invitation to the Playcelet apps associated with the invited friends. The Playcelet app for each invitee receives (at block 440) the invitation with response buttons, which response buttons disappear (at block 445) when the invitation expires (block 430). The Playcelet app directs the Playcelet of the invited friend to indicate that an invitation has been received. For example, a light on the Playcelet may be directed to turn on periodically, such as once per minute. Accordingly, the Playcelet provides (at block 450) the indication as instructed. In some embodiments, each person in the play network chooses a color by which to be represented, and the indication provided (block 450) by the Playcelet includes the chosen color of the inviter. The indication ends when the invitation expires (block 430) or at a preset time before the invitation expires, such as fifteen minutes before the invitation expires.

In one or more embodiments, invitation data is transmitted securely. For example, using a Playcelet's public/private key pair, when an invitation is sent to a Playcelet, it includes a secret, one time “invite code” encrypted with the public key of the Playcelet generated by the computing device sending the initial invitation. The invite also includes the public key associated with the sender of the invitation. The Playcelet uses its private key to decrypt the invite code.

Referring to FIG. 5, an example of the respond functionality of FIG. 2 (blocks 215, 216, 220, 221) is provided. The Playcelet app of an invitee indicates that an invitation has arrived, and response buttons (e.g., “Yes” and “No”) are provided. If the “Yes” response is selected (at block 505), an end time may be optionally be selected (at block 510). In some embodiments, a start time may also be selected, to indicate that the invitee would like to attend, but will be late. The invitation is accepted within the Playcelet app, and the Playcelet app sends (at block 515) the acceptance to the Playcelets server, indicates (at block 520) that the invitation was accepted, and instructs the invitee's Playcelet to provide an indication that the Playcelet is waiting to be checked in at the designated destination. The Playcelet provides (at block 525) the instructed indication, such as a rapid flash of a light. As shown in FIG. 5, such a rapidly flashing light may be in color selected to represent the invitee. Alternatively, the color may represent the inviter. The server notifies (at block 530) the Playcelet app of the inviter that the invitation was accepted, and the Playcelet app indicates (at block 535) that the acceptance was received, and instructs the inviter's Playcelet to indicate the invitation. The Playcelet of the inviter provides (at block 440) the instructed notification, such as flashing a light in the color of the friend that accepted. In some embodiments, the Playcelet continues to flash a light in the color of the friend that accepted until the Playcelet of that friend checks in with the inviter's Playcelet app.

If, instead of a “Yes” response being selected (block 505), a “No” response is selected (at block 545), the Playcelet app sends (at block 550) a decline notice to the Playcelets server. The Playcelets server notifies (at block 555) Playcelet apps of the inviter and the decliner. The inviter Playcelet app indicates (at block 560) the decline. If all invitees have declined, the inviter Playcelet app instructs the inviter Playcelet to stop the indication of the active invitation that was initiated when the invitation was sent (FIG. 2, block 206), and the inviter Playcelet stops (at block 565) the indication. The invitee Playcelet app indicates (at block 570) that the invitation was declined, and instructs the invitee Playcelet to stop the indication of the active invitation that was initiated when the invitation was received (FIG. 2, block 211). The invitee Playcelet stops (at block 575) the indication. In an alternative embodiment, when the invitation is declined (block 550), the invitee Playcelet app indicates (block 570) that the invitation was declined and instructs the invitee Playcelet to stop the indication of the active invitation without waiting for instruction from the Playcelets server (block 555).

In one or more embodiments, responses are generated securely. For example, a one-time, unique invitation code is referenced, and the response is encrypted using first the Playcelet's private key and then the sender's public key (the sender of the invite). It can then begin transmitting this encrypted message (or a fingerprint or hash of the message) over a wireless network or protocol to the Playcelet. Any devices that detect the wireless message would not be able to decode it or to track it to the Playcelet.

Referring to FIG. 6, an example of the check-in functionality of FIG. 2 (blocks 225, 226) is provided. In FIG. 6, the inviter Playcelet app is waiting for Child X to arrive. Child X has accepted the invitation but has not checked in. The inviter Playcelet app scans (at block 605) periodically for Playcelets generally, such as once per minute. If Child X has not arrived, and it has been less than fifteen minutes since the invitation to Child X was accepted, the inviter Playcelet app continues its periodic scan for Playcelets. If it has been more than fifteen minutes since the invitation to Child X was accepted and Child X has still not arrived, the inviter Playcelet app sends a notice to the Playcelets server of the overdue arrival of Child X. Alternatively, the Playcelets server monitors the time, and identifies that Child X has not arrived within fifteen minutes. Note that fifteen minutes is used by way of non-limiting example. Additionally, in some embodiments, the invitee Playcelet app may indicate a specific time or passage of time for an indication of overdue arrival to be triggered. The Playcelets server sends (at block 610) a notification of overdue arrival to the inviter Playcelet app (in the case in which the Playcelets server monitors for overdue arrival), and sends (at block 620) a notification of overdue arrival to the invitee Playcelet app. If less than twenty-five minutes (or some other time) has passed since the invitation to Child X was accepted, the inviter Playcelet app continues to scan (at block 605) for Playcelets. If twenty-five minutes or more have passed since the invitation to Child X was accepted, and Child X has still not arrived, another overdue arrival is identified, and the Playcelets server sends (blocks 610, 615, 620) another overdue arrival message to the inviter and invitee Playcelet apps.

If at any time, Child X does arrive, the check-in of Child X proceeds (at block 625, described in FIG. 7), and the indication on the inviter and invitee Playcelets with respect to waiting for check-in of Child X ceases (at blocks 630, 635). The Playcelets server (or the inviter Playcelet app) determines whether all children included in the invitation either declined the invitation or have been checked in. For example, some invitees may not accept or decline, but may show up anyway. If all invitees either arrived or declined, then the inviter Playcelet app enters (at block 640, described with respect to FIG. 8) a monitoring state.

If one or more invitees did not decline and has not arrived, the inviter Playcelet app enters a reduced-frequency scan state, in which it scans (at block 645) for Playcelets less frequently, such as every five minutes, until the invitation expires. For each Playcelet found, if the child was not already checked in, the child is checked in (at block 650, described with respect to FIG. 7), and if all invited children are checked in or declined, the inviter Playcelet app enters (at block 660, described with respect to FIG. 8) the monitoring state. In the reduced-frequency scan (block 645), if one of the checked-in Playcelets is not found for a time, a check-out sequence is initiated (at block 665, described with respect to FIG. 8).

Also shown in FIG. 6 is that, if there are no active invitations, the Playcelet app enters a lower-frequency scan, such as scanning (at block 670) every ten minutes. Then, if a Playcelet is found, it is checked in (at block 675, described with respect to FIG. 7), but not monitored.

Referring to FIG. 7, when a Playcelet is in range of a Playcelet app (at block 705) and not already checked in (for example, blocks 625, 650, 675 of FIG. 6), the Playcelet app sends (at block 710) a notification to the Playcelets server. The Playcelets server sends (at block 715) a notification to both the Playcelet app that identified the Playcelet to be checked in, and the Playcelet app associated with the Playcelet to be checked in, both of which indicate the same (at blocks 720, 725). Once the invitee checks in, the invitation shine (in this example) will stop on the Playcelets of both the inviter and the invitee (in blocks 730 and 735). In some embodiments, the specific location of the Playcelet in relation to the mobile phone or the GPS location of the mobile phone is also securely transmitted and displayed via the Checked In interface of the mobile app. In one or more embodiments, the Playcelets network is secure, and only members of Playcelets' play networks will have the ability to decode messages and Playcelets signals to pass message and/or location data of devices on to Playcelets or to the server.

Referring to FIG. 8, an example of the monitoring of FIG. 2 (block 225) is provided, once all of the invitees have either declined or checked in. The example of FIG. 8 is described with respect to the monitoring of a single checked-in Playcelet of Child X, but it should be understood that the monitoring is of all of the checked-in Playcelets. The inviter Playcelet app looks for (at block 805) the Playcelet of Child X periodically, such as every two minutes. The check is referred to as a “battery check” to indicate that Child X may be in the proximity of the inviter Playcelet app, and it also provides the app with information about the battery level of the Playcelet device, so it may notify the user via the app when the battery is running low. If the Playcelet is found, the check continues periodically (block 805). If the Playcelet is not found in five checks, the inviter Playcelet app notifies (at block 820) the Playcelets server that there was a check-out of the Playcelet of Child X. The Playcelets server notifies (at block 825) the Playcelet app associated with the Playcelet of Child X that there was a check-out of the Playcelet, and the Playcelet app associated with Child X correspondingly provides (at block 830) a notification. Alternatively or additionally, the Playcelets server notifies (at block 825) the inviter Playcelet app to provide a notification of the check-out of the Playcelet, and the inviter Playcelet app provides (at block 830) a notification.

The inviter Playcelet app then begins an increased-frequency scan, for example, scanning (at block 835) every minute. If the Playcelet of Child X is then found (at block 845), the inviter Playcelet app sends (at block 845) a notification to the Playcelets server, the Playcelets server notes (at block 850) the check-in, and the inviter Playcelet app indicates (at block 855) the check-in and proceeds based on whether all of the invitees either declined or are checked in. If the Playcelet of Child X was not found for nine scans (at block 860), the inviter Playcelet app notifies (at block 865) the Playcelets server that there is a stage two checkout (Check Out 2), the Playcelets server notes the stage two checkout and notifies (at block 870) the Playcelet app associated with Child X, which then indicates (at block 875) the stage two checkout. The inviter Playcelet app also indicates (at block 880) the stage two checkout. The increased-frequency scan is continued until Child X is checked in.

Referring to FIG. 9, an example of the come home signaling of FIG. 2 (blocks 230, 231, 235, 236, 240) is provided. At a point shortly before the end time of the invitation, such as seven minutes before, the Playcelets server notifies (at block 905) that play time is ending. The inviter Playcelet app provides (at block 910) an indication of the impending end, and each of the invitee Playcelets (and optionally the inviter Playcelet) provides an indication that play time is ending. For example, each Playcelet flashes (at block 915) the selected color of the child associated with the Playcelet, such as flashing five times per second or minute, and the child presumably begins (at block 920) the journey homeward. At some point between the play destination and the home, the inviter Playcelet app is no longer able to receive the transmissions from the invitee Playcelet.

Meanwhile, the Playcelet app associated with the child traveling home scans (at block 925) periodically for the Playcelet, such as every two minutes. If the child arrives, the invitee Playcelet app checks in (at block 930, described with respect to FIG. 9) the Playcelet, notifies the Playcelet to stop flashing (which it does at block 935) and stops the frequent scanning (initiated at block 925). If, however, the scan (block 925) does not detect the Playcelet within a time, such as six minutes after the end of the invitation play time, either the Playcelet app or the Playcelets server will provide an indication that the child was overdue home, and the Playcelets server will notify (at blocks 950, 955) the inviter Playcelet app and the invitee Playcelet app. The scanning (block 925) continues until the Playcelet being scanned for is checked in.

FIGS. 2-9 thus describe examples of techniques for establishing a spontaneous play invitation within a play network, and monitoring of invitees from the time the invitation was sent until the invitees return home at the end of play. The examples are not limiting, and modifications of the techniques, such as additions, subtractions, or reordering, are within the scope of the present disclosure.

Additionally, although described with respect to play networks, the techniques encompassed by the present disclosure are useful in other areas as well. For example, the techniques may be used to track attendance at school and at after-school events. One can imagine a check in for school attendance each day, where a minor child is tracked from home and to school, monitored at school, and tracked from school to home. One can further imagine check ins for after-school activities, such as band or football practice, where the minor child is further tracked from school to the after-school activity, monitored while there, and tracked coming home. With such a system, parental concern over the safety of the minor child may be reduced. Further, because the Playcelet app may be instantiated on a mobile device, a parent may monitor a minor child between home, school, activities, and friends' houses, while the parent is at work. This allows the child to engage in more activities, while reducing parental concern.

Although described with respect to a wristband, a Playcelet may be in any form, such as other types of wearable devices.

In a prototype Playcelet, the electronics of the Playcelet are incorporated into a light-up Playcelet charm. A Playcelet is formed by including the Playcelet charm onto a band. For example, children can weave custom bracelets including the Playcelet charm, to fit their personalities and sizes. A social group can choose to color-code the bracelets, such as by each child choosing a color to include on the bracelet, and that same color is used to correspond to the color in which the bracelet lights up for messages sent from that child. Additionally, a social group can choose to include indications of other member of the group, such as specific shapes or colors of beads, or letter beads, where each bead represents a specific child. Other charms or beads may also be included. In a kit embodiment, accessory kits provide materials to help the children weave their unique bracelets.

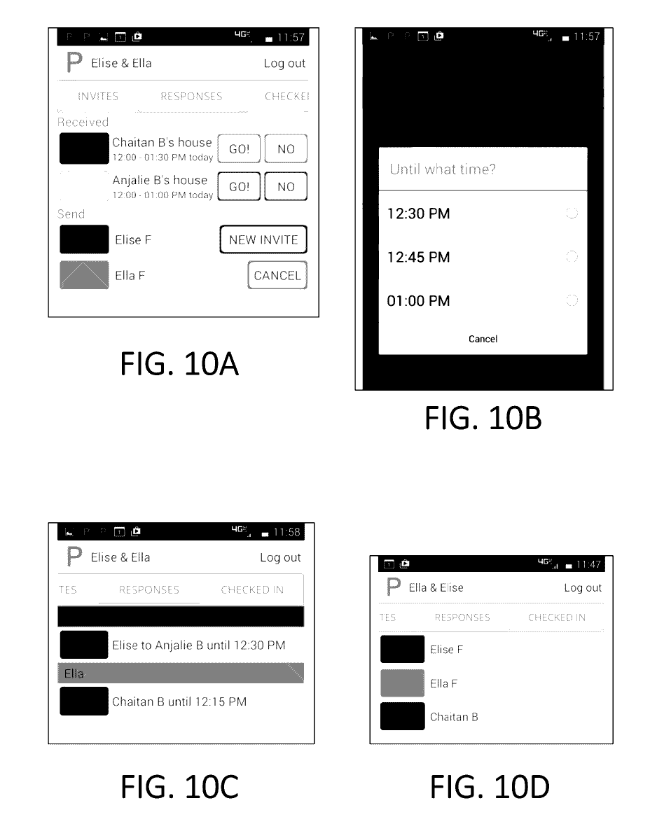

FIGS. 10A-10D illustrate screenshots from a prototype Playcelet app. FIG. 10A illustrates an invite tab for two children associated with the Playcelet app, FIG. 10B illustrates an end time selection screen, FIG. 10C illustrates a response tab, and FIG. 10D illustrates a checked-in tab for a particular invitation.

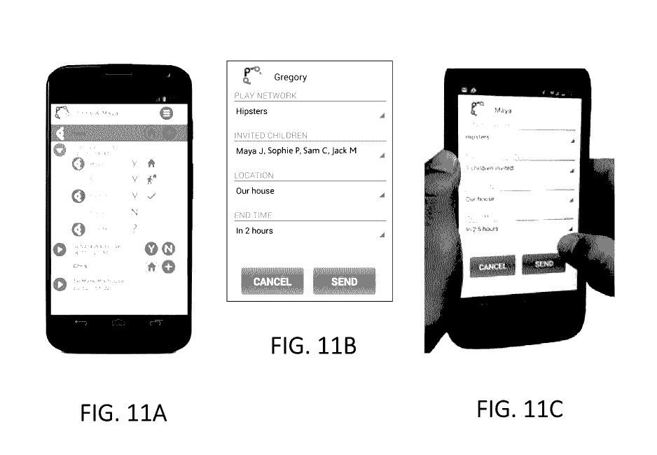

FIGS. 11-11C illustrate screenshots from a prototype Playcelet app. FIG. 11A illustrates a dashboard associated with the Playcelet app, FIG. 11B illustrates an invitation creation screen, and FIG. 11C illustrates another invitation creation screen.

While the disclosure has been described with reference to the specific embodiments thereof, it should be understood by those skilled in the art that various changes may be made and equivalents may be substituted without departing from the true spirit and scope of the disclosure as defined by the appended claims. In addition, many modifications may be made to adapt a particular situation, material, composition of matter, method, operation or operations, to the objective, spirit and scope of the disclosure. All such modifications are intended to be within the scope of the claims appended hereto. In particular, while certain methods may have been described with reference to particular operations performed in a particular order, it will be understood that these operations may be combined, sub-divided, or re-ordered to form an equivalent method without departing from the teachings of the disclosure. Accordingly, unless specifically indicated herein, the order and grouping of the operations is not a limitation of the disclosure.

What is claimed is:

1. A system, comprising:
a first wearable device including a wireless communication interface and a user interface; and
instructions stored in a tangible computer-readable memory, the instructions comprising instructions to:
provide a graphical user interface;
receive at the graphical user interface instructions for creating an invitation including a destination and a list of invitees;
send to a server a description of the invitation;
receive from the server a notification that the invitation was delivered; and
instruct the first wearable device to indicate that the invitation was delivered.

2. The system of claim 1, the instructions further comprising instructions to:
monitor for a second wearable device; and
when the second wearable device is detected, check in the second wearable device.

3. The system of claim 2, wherein the second wearable device is associated with an invitee of the list of invitees.

4. The system of claim 2, the instructions further comprising instructions to, subsequent to checking in the second wearable device:
monitor for the first wearable device and the second wearable device; and
in a case in which the first wearable device or the second wearable device is not detected, provide a checkout notification to the server.

5. The system of claim 2, the instructions further comprising instructions to instruct the first wearable device and the second wearable device to each indicate a return home notification.

6. The system of claim 2, the instructions further comprising instructions to provide an overdue notification to the server if the second wearable device is not detected within a predefined time period.

7. The system of claim 6, the instructions further comprising instructions to continue to monitor for the second wearable device after providing the overdue notification.

8. The system of claim 1, wherein the description of the invitation includes an expiration time of the invitation.

9. The system of claim 1, the wearable device comprising:
a graphical user interface;
a wireless interface; and
a controller configured to receive instructions through the wireless interface to control the graphical user interface to indicate that a request is pending, and further configured to provide a notification through the wireless interface.

10. A computer program product comprising instructions to:
provide a graphical user interface;
receive at the graphical user interface instructions for creating an invitation including a destination and a list of invitees;
send to a server a description of the invitation;
receive from the server a notification that the invitation was delivered; and
instruct a first wearable device to indicate that the invitation was delivered.

11. The computer program product of claim 10, the instructions further comprising instructions to:
monitor for a second wearable device; and
when the second wearable device is detected, check in the second wearable device.

12. The computer program product of claim 11, wherein the second wearable device is associated with an invitee of the list of invitees.

13. The computer program product of claim 11, the instructions further comprising instructions to, subsequent to checking in the second wearable device:
monitor for the first wearable device and the second wearable device; and
in a case in which the first wearable device or the second wearable device is not detected, provide a checkout notification to the server.

14. The computer program product of claim 11, the instructions further comprising instructions to instruct the first wearable device and the second wearable device to each indicate a return home notification.

15. The computer program product of claim 11, the instructions further comprising instructions to provide an overdue notification to the server if the second wearable device is not detected within a predefined time period.

16. The computer program product of claim 15, the instructions further comprising instructions to continue to monitor for the second wearable device after providing the overdue notification.

17. The computer program product of claim 10, wherein the description of the invitation includes an expiration time of the invitation.

18. A server, comprising:
a processor and a memory having instructions stored thereon configured to cause the processor to:
receive a request for a meeting from a computing device associated with an inviter, the request including identifiers of a location and at least one invitee;
transmit a notification of the request for the meeting to a computing device associated with the invitee;
receive an acceptance from the computing device associated with the invitee;
transmit a notification of the acceptance to the computing device associated with the inviter;
receive a notification of an arrival of the invitee at the location; and
transmit a notification of the arrival to the computing device associated with the invitee.

19. The server of claim 18, the instructions further configured to cause the processor to:
determine that a predefined time has elapsed since the acceptance was received from the computing device associated with the invitee, and that an arrival notice related to the invitee was not subsequently received; and
provide a notification to the computing device associated with the inviter and the computing device associated with the invitee that arrival is overdue.

20. The server of claim 18, the instructions further configured to cause the processor to:
receive status updates from the computing device associated with the inviter;
identify from the status updates that the invitee or the inviter is not found; and
provide a notification to the computing device associated with the inviter and the computing device associated with the invitee that a checkout has occurred.
